(19) United States
(12) Patent Application Publication
(10) Pub. No.: US 2026/0338662 A1
(43) Pub. Date: Oct. 29, 2026

(54) DEVICE FOR ANALYZING SAMPLES OF MICROORGANISMS IN LIQUIDS

(71) Applicants: TOTALENERGIES ONETECH, Courbevoie (FR); ZORTH, Aix en Provence (FR)

(72) Inventors: Florian MONLAU, Pau (FR); Cecilia SAMBUSITI, Pau (FR); Nicolas BARBARIN, Pau (FR); Bruno CONCHE, Pau (FR); David Alexis MENDELS, Aix en Provence (FR); Gary ATKINSON, Aix en Provence (FR)

(21) Appl. No.: 19/120,511

(22) PCT Filed: Oct. 12, 2022
(86) PCT No.: PCT/IB2022/000587

§ 371 Date: Apr. 11, 2025

(51) Int. Cl. G01N 15/1409; G01N 15/10; G01N 15/14; G01N 15/1429; G01N 15/1433; G01N 15/1434

(52) U.S. Cl. CPC G01N 15/1409; G01N 15/1431; G01N 15/1433; G01N 15/1436; G01N 15/147; G01N 2015/1006

(57) ABSTRACT

The disclosure notably relates to a device for analyzing samples of liquids containing microorganisms. The device comprises fluidics system. The fluidics system comprises a liquid input channel configured to take in a liquid containing microorganisms from an external liquid medium, a dilutant input channel configured to take in dilutant from a dilutant source, and a microfluidic slide. The microfluidic slide is configured for receiving a mixture of the liquid from the liquid input channel and of the dilutant from the dilutant input channel. The device also comprises an optics system. The optics system comprises a microscope. The microscope is arranged for capturing a flux of images of the microfluidic slide. The device also comprises an electronic system. The electronic system comprises a processing unit configured for receiving and processing of the flux of images from the microscope.

### TECHNICAL FIELD

The disclosure relates to the field of electronic systems, and more specifically to a device, a computer program and a method for analyzing samples of liquids containing microorganisms.

### BACKGROUND

Microorganisms in liquids (e.g., bacteria, fungi, microalgae, archaea or protists) must be regularly analyzed when these are used in industrial production. This is the case, for instance, of microalgae cultures found in wastewater or bioreactor ponds, where the microalgae cultures are analyzed by using high-throughput sequencing methods and by quantitative Polymerase Chain Reaction (qPCR) methods for detecting eukaryotic and prokaryotic populations present within the culture. The analysis allows to make qualitative assertions concerning the nature of the microorganisms, e.g., its species within a family or genus and their state of health. However, the analysis may take several months to provide relevant results. This analysis can therefore be very time and resource consuming in systems where it is of utmost importance to prevent any degradation of the culture.

Other methods may couple microfluidic sensors for the detecting of microalgae. These microfluidic sensors, e.g., optical density, turbidity, fluorometry, flow cytometry, have been put into practice coupled with microfluidic tools for monitoring the growth of cultures. However, these solutions are not known to work properly in continuous flow, and do not allow to make a classification of the typology of the microalgae.

In other situations, liquid media may need analysis to detect potential unwanted microorganisms therein. Regular analysis may help prevent such contamination or react thereto.

The detection of microorganisms is of importance in a variety of industrial applications, such as for detecting contaminants in wastewater tanks found in water treatment plants, detecting phytoplankton (or diatoms or zooplankton) on open sea, oceans or lakes. Other examples include detecting microalgae or cyanobacteria on liquid contained on photobioreactors, raceways, lakes or natural basins. In addition, the detection of microorganisms is important for biofuel or green gas productions, where it is important to monitor the health of the microorganisms. Further, the detection of microorganisms is important on any industrial application of microalgae or cyanobacteria applications, e.g., for cosmetics, pesticides, pharma, farming, biomaterials, among others.

In other examples, the detection of microorganisms such as yeasts, bacteria or archae found in biological reactor liquids is of importance for the production of products such as bioethanol biohydrogen biogas biodiesel or biopolymers.

In other examples, the detection of microorganisms such as bacteria or archae, found on civil and/or industrial wastewater treatment plants is relevant for aerobic and/or anaerobic biological tank wastewater treatment.

In other example, detecting unwanted contaminants found in large oil tanks, which may in certain circumstances be contaminated by molds or fungi. This is also the case for ensuring industrial hygiene of the liquid medium.

Here again, existing solutions may be slow and cumbersome, as they usually involve manually taking samples of the liquid and manually analyzing such samples.

Within this context, there is still a need for an improved solution for analyzing samples of liquids containing microorganisms.

### SUMMARY

It is therefore provided a device for analyzing samples of liquids containing microorganisms. The device comprises a fluidics system. The fluidics system comprises a liquid input channel configured to take in a liquid containing microorganisms from an external liquid medium, a dilutant input channel configured to take in dilutant from a dilutant source, and a microfluidic slide. The microfluidic slide is configured to receive a mixture of the liquid from the liquid input channel and of the dilutant from the dilutant input channel. The device also comprises an optics system. The optics system comprises a microscope. The microscope is arranged for capturing a flux of images of the microfluidic slide. The device also comprises an electronic system. The electronic system comprises a processing unit configured for receiving and processing of the flux of images from the microscope.

The device may comprise one or more of the following:

the processing unit is configured for driving the input channels;

the processing unit is configured for varying a proportion of dilutant in the mixture;

the processing unit is configured for performing an estimation of a mass of microorganisms in the flux of images, and for performing the variation of the proportion of dilutant in the mixture based on the estimated mass;

performing the estimation of the mass of microorganisms in the flux of images comprises applying one of:

an adaptive thresholding on the flux of images, the adaptive thresholding creating at least one segment on the flux of images, the area of the at least one segment comprising at least one or more microorganism, and

a neural network classifier on the flux of images, the neural network classifier being configured to determine the mass of microorganisms on the flux of images;

the processing unit is configured for enabling flow of the dilutant into the mixture when the estimated mass of microorganisms is above a predetermined threshold, and for disabling flow of the dilutant into the mixture otherwise;

the receiving and processing of the flux of images comprises detecting microorganisms present in the flux of images estimating a value of one or more biological attributes of microorganisms present in the flux of images;

the electronic system comprises a memory having recorded thereon one or more neural networks configured for performing the detection and/or estimation (of the microorganisms), the processing unit optionally being configured for applying the one or more neural networks to the flux of images so as to perform the detection and/or estimation;

each neural network is trained according to a machine-learning method comprising:

providing a dataset comprising a set of training patterns, each training pattern comprising a microscope image of a sample of a liquid medium containing microorganisms and one or more annotations, including at least one annotation comprising an indication relative to a presence in the image of at least one given microorganism (e.g., at least one annotation indicating a presence in the image of at least one given microorganism), and/or a plurality of annotations each comprising a localization (i.e., position) in the image containing at least one given microorganism, and optionally further, a value of one or more respective biological attributes for the at least one given microorganism; and

training the neural network based on the provided dataset;

the liquid input channel comprises one or more surfaces having hydrophobic properties;

the optics system comprises a light source, a light source intensity modulator, an Abbe type condenser, an objective, at least one convergent lens, a diaphragm and an integrated electronic camera;

the microfluidic slide comprises a liquid channel having a cross-section of thickness between 50 μm and 1 mm and of width between 200 μm and 10 mm;

wherein the processing unit is configured for providing pulsations to the liquid input channel of a first predetermined duration, the pulsations being configured so that the liquid input channel takes in liquid from the external liquid medium during the first predetermined duration, and wherein the capturing of the flux of images from the microscope comprises stopping the providing of pulsations during a second predetermined duration;

the device further comprises one or more supporting structures, the one or more supporting structures being arranged so as to define a supporting direction for the device;

the microfluidic slide is arranged in a direction parallel to the supporting direction of the device;

the microfluidic slide is arranged so as to take in the mixture and then throw out said mixture along the supporting direction of the device;

the electronic system further comprises a transmission system configured for transmitting the obtained flux of images;

the fluidics system also comprising a mixer, such as a Y-mixer or a T-mixer, the mixer being configured for receiving the liquid containing microorganisms taken in from the liquid input channel and the dilutant taken in from the dilutant input channel, and for supplying the mixture to the microfluidic slide; and

the electronic system is further configured to determine a universal time and a localization of each captured image.

It is further provided a computer program comprising instructions configured for causing a processor to display on a screen a graphical user interface (GUI) configured for user-interaction with the device.

It is further provided a method for analyzing samples of liquids containing microorganisms. The method comprises providing the device. The method also comprises connecting the liquid input channel to an external liquid medium containing microorganisms. The method also comprises taking liquid from the external liquid medium into the liquid input channel. The method also comprises, at the microfluidic slide, receiving the liquid from the input liquid channel or a mixture of the liquid from the liquid input channel and of dilutant from the dilutant input channel. The method also comprises capturing a flux of images of the microfluidic slide with the microscope. The method also comprises receiving and processing the flux of images with the electronic system.

The method may comprise one or more of the following:

the method comprises arranging the device such that the device is supported vertically, the microfluidic slide being arranged vertically, the liquid or mixture optionally flowing upwardly in the microfluidic slide;

the external liquid medium is a pond of a bioreactor or an oil tank subject to presence of molds.

### BRIEF DESCRIPTION OF THE DRAWINGS

Non-limiting examples will now be described in reference to the accompanying drawings, where:

FIGS. 1 to 4 show schematic examples of the device;

FIG. 5 shows examples of industrial premises where the device may be deployed;

FIG. 6 shows examples of applications of the device; and 6 shows examples of results obtained by applications of the device;

FIG. 7 shows an example of a remote system that may communicate with the device; and

FIG. 8 shows an example of the GUI.

### DETAILED DESCRIPTION

The device comprises a fluidics system. The fluidics system comprises a liquid input channel configured to take in a liquid containing microorganisms from an external liquid medium. The fluidics system comprises a liquid input channel configured to take in, from an external liquid medium, a liquid containing microorganisms. The fluidics system also comprises a dilutant input channel configured to take in dilutant from a dilutant source. The fluidics system also comprises a dilutant input channel configured to take in, from a dilutant source, dilutant. The fluidics system also comprises a microfluidic slide. The microfluidic slide is configured for receiving a mixture of the liquid from the liquid input channel and of the dilutant from the dilutant input channel. The microfluidic slide is configured for receiving a mixture of the liquid (taken in the liquid input channel) from the liquid input channel and of the dilutant (taken in dilutant input channel) from the dilutant input channel. The device also comprises an optics system. The optics system comprises a microscope. The microscope is arranged for capturing a flux of images of the microfluidic slide. The device also comprises an electronic system. The electronic system comprises a processing unit. The processing unit is configured for receiving and processing of the flux of images from the microscope.

The device improves the analysis of samples of liquids containing microorganisms.

Indeed, as the microfluidic slide is configured to receive the mixture of the liquid from the liquid input channel and of the dilutant from the dilutant input channel, this allows an efficient flow of the microorganisms contained in the liquid. Indeed, the electronic system captures continuously (e.g., “on the fly”) a flux of images which corresponds to a stream of microorganisms as these traverse the fluidics system. This further allows an improved discrimination and analysis of the microorganisms contained in the liquids. The dilution indeed avoids saturation of the analyzed sample of liquids by a too high number of microorganisms, thus facilitating subsequent image analysis by the electronic system. Indeed, image analysis techniques may not work correctly when there are too many microorganisms in the liquid, as the discrimination of individual microorganisms becomes more difficult. In addition, the input of dilutant reduces the formation of sediments in the fluidics system. Thus, the device improves the analysis of images (e.g., allowing a processing on-the-fly) of the liquids, thereby reducing waiting times and further improving reliability against the formation of sediments or clogs in the fluidics system.

The device also improves the analysis of samples of liquids containing microorganisms. Indeed, as the microfluidic slide is configured to receive the mixture of the liquid from the liquid input channel and of the dilutant from the dilutant input channel, the device reduces the formation of sediments in the fluidics system. This allows an efficient flow of the microorganisms contained in the liquid, so that the electronic system captures continuously (e.g., “on the fly”) a flux of images which corresponds to a stream of microorganisms as these traverse the fluidics system. This allows an improved discrimination and analysis of the microorganisms contained in the liquids. Thus, the device allows a processing on-the-fly of the images of the liquids, thereby reducing waiting times and improving reliability against the formation of sediments or clogs in the fluidics system.

It is accordingly further proposed a method for analyzing samples of microorganisms in liquid media. The method comprises providing the device. The method also comprises connecting the liquid input channel to an external liquid medium containing microorganisms. The method also comprises taking liquid from the external liquid medium into the liquid input channel. The method also comprises, at the microfluidic slide, receiving the liquid from the input liquid channel or a mixture of the liquid from the liquid input channel and of dilutant from the dilutant input channel. The method also comprises capturing a flux of images of the microfluidic slide with the microscope. The method also comprises receiving and processing the flux of images with the electronic system.

It is also proposed a computer program comprising instructions configured for causing a processor to display on a screen a graphical user interface (GUI) configured for user-interaction with the device.

The computer program may comprise instructions executable by the processor, the instructions comprising means for displaying on the screen GUI. The program may be recordable on any data storage medium, including the memory of the device. The program may for example be implemented in digital electronic circuitry, or in computer hardware, firmware, software, or in combinations of them. Method steps may be performed by a programmable processor executing a program of instructions to perform functions of the method by operating on input data and generating output. The processor may thus be programmable and coupled to receive data and instructions from, and to transmit data and instructions to, a data storage system, at least one input device, and at least one output device and/or an external system. The application program may be implemented in a high-level procedural or object-oriented programming language, or in assembly or machine language if desired. In any case, the language may be a compiled or interpreted language. The program may be a full installation program or an update program. Application of the program by the processor results in any case in instructions for displaying the GUI. The computer program may alternatively be stored and executed on a remote system or server of a cloud computing environment, the server being in communication across a network with the device. In such a case the processor executes the instructions comprised by the program, thereby causing the display of the GUI to be performed on the cloud computing environment.

The GUI may be configured for providing instructions to the electronic system. The GUI may comprise interface screens (such as web interface screens) allowing user input for interacting with the device. For example, the GUI may comprise interface screens for varying the proportion of dilutant in the mixture so as to dilute the liquid received from the liquid input channel. In other examples, the GUI may comprise a graphical screen configured for displaying the flux of images.

The processor may be the processing unit on the device, and the screen may be mounted or attached in the device for allowing user interaction.

The liquid containing microorganisms from an external liquid medium may be any incompressible fluid, e.g., comprising or consisting of water and oil. The microorganisms may comprise or consist of microalgae, cyanobacteria, and/or molds.

The fluidics system, the optics system and the electronic system may be disposed in any manner in the device. For example, the fluidics system, the optics system and the electronic system may be integrated into the device, i.e., attached as a single unit.

Alternatively, at least one of the fluidics system, the optics system and/or the electronic system (e.g., each one of the fluidics system, the optics system and the electronic system) may be an independent system. For example, each one of the fluidics system, the optics system and the electronic system may be detachable from the device; the system may have connectors adapted for attaching/detaching the at least one of the fluidics system, the optics system and the electronic system into the device as needed. The device may also comprise circuitry adapted for allowing the data transmission between the fluidics system, the optics system and the electronic system. When at least one of the fluidics system, the optics system and/or the electronic system is an independent system, the independent system may be enclosed into an enclosure. The enclosure may comprise inputs and outputs configured to be attached to the device.

In examples, the fluidics system may be an independent system and may be contained in a waterproof enclosure. Thus, the optics system and the electronic system may be protected from leaks of liquid. The optics system and/or the electronic system may also be contained in a waterproof enclosure to prevent accidental spills of liquid.

The optics system comprises a microscope. The microscope is arranged for capturing a flux of images of the microfluidic slide. In other words, the microscope is positioned within the optics system so that the microscope acquires the flux of images from the mixture received by the microfluidic slide.

By “flux of images” it is meant a succession (e.g. a time-series) of images. The flux of images is thus a set of successive images representing at least part of the mixture of the liquid received by the microfluidic slide. Each image may be a color (e.g., RGB) or grayscale image. The capturing may be performed continuously, such that two successive images of the video flux may be separated by a relatively short predetermined period of time (e.g. separated by 1 second or 0.33 seconds or less).

The fluidics system may comprise a set of circuits, sensors, or elements adapted for allowing the retrieval and/or disposal of liquid, so that the optics system captures the flux of images (corresponding to images of the fluid containing microorganisms) of the microfluidic slide. The fluidics system comprises the liquid input channel. The liquid input channel is configured to take in a liquid containing microorganisms from the external liquid medium. The liquid may be conveyed to the liquid input channel through a liquid conduit (e.g., flexible tube) connected to the external liquid medium. The liquid conduit may be part of or external to the device. The device may include a liquid input port which may be configured for connecting or disconnecting the liquid conduit from the device. The liquid input port may be arranged on the enclosure of the device. The liquid input port may be connected at one end to the liquid conduit, and at the other end to the liquid input channel.

The liquid input channel may have any geometry (e.g., straight, or allowing a degree of curvature) adapted for allowing the flow of the liquid in a small scale (e.g., sub-millimeter scale). The liquid input channel may be made of a flexible or rigid material.

The fluidics system also comprises the microfluidic slide. By “microfluidic”, it is meant any property for allowing the control and manipulation of fluids in a small scale, e.g., below 1 mm or less, even at micro-meter scale or less. The microfluidic slide may be a microscopically thin flat conduit made (at least in part) of transparent material, e.g., a conduit enclosed by a pair of parallel sheets of transparent material such as glass separated by a gap (also called “channel”). A conduit enclosed by a pair of parallel sheets of transparent material such as glass separated by a gap (also called “channel”). The gap between the pair of parallel sheets may allow the flow of liquid in its interior. The microfluidic slide is configured for receiving a mixture of the liquid from the liquid input channel and of the dilutant from the dilutant input channel. The microfluidic slide may have at least one entry connector (e.g., a Luer connector) be fed from the liquid input channel and the dilutant input channel, e.g., two independent connectors that are connected to the microfluidic slide (and thus the liquid and the dilutant mix within the microfluidic slide) or (alternatively) a single connector (and thus the liquid and the dilutant mix are already mixed when entering the microfluidic slide) configured to maintain the mixture of the liquid and/or throw out said liquid. The microfluidic slide may have at another output connector configured for throwing out the mixture.

The microfluidic slide may comprise a liquid channel, e.g., disposed between the gap when the microfluidic slide consist of two parallel sheets of transparent material). The liquid channel may be a path engraved on the microfluidic slide. The liquid channel may have a geometrical cross-section (taken perpendicular to the direction of the mixture along the slide) having a thickness between 50 μm and 1 mm and of width between 200 μm and 10 mm. This ensures that the flow of the mixture of the liquid is constrained along the path of the liquid channel. Hence, the microscope improves its focus on capturing the flux of images on the liquid channel, thereby obtaining an improved quality of the flux of images.

The liquid input channel may comprise one or more surfaces having hydrophobic properties. By hydrophobic properties it is meant that the one or more surfaces repel or at least do not absorb water. The microfluidic slide may also have hydrophobic properties.

The liquid input channel comprising one or more surfaces having hydrophobic properties reduces the formation of clogs in the liquid input channel, as the one or more surfaces facilitate the passing of the liquid along the input channel and the microfluidic slide. Hence, the flow of the liquid containing microorganisms from the external liquid medium through the liquid input channel is improved.

The fluidics system also comprises the dilutant input channel. The dilutant input channel is configured to take in dilutant from a dilutant source. The dilutant source may be any source having a dilutant. The dilutant may be a liquid having a same polarity as the external liquid medium, which has a capability to be mixed with the liquid of the external liquid medium For example, the dilutant may be fresh water for diluting liquid coming from a bioreactor pond, salt water for diluting an external medium of sea water, filtered oil for diluting an oil from a large oil tank, or a solvent that mixes with the liquid from the external liquid medium.

The dilutant may be conveyed to the dilutant input channel through a dilutant input conduit (e.g., flexible tube) connected to an external dilutant medium (such as a reservoir of water). The dilutant input conduit may be part of or external to the device. The device may include a dilutant input port which may be configured for connecting or disconnecting the dilutant input conduit to/from the device. The dilutant port may be arranged on the enclosure of the device. The dilutant input port may be connected at one end to the dilutant conduit, and at the other end to the dilutant input channel.

Alternatively, the dilutant source may be a reservoir placed inside the device (e.g., a portable reservoir). The dilutant port may thus be arranged inside the device, e.g., as part of the fluidics system.

By “mixture” it is meant any combination of the liquid from the liquid input channel and the dilutant input channel. The combination may have any proportion of (e.g., a non-null) volume of liquid with respect to a (e.g., non-null) volume of the dilutant. The device may be configured for supplying selectively the proportion of volume of liquid with respect to the volume of dilutant, e.g., supplying only the liquid.

The fluidics system may comprise a mixer such as a Y-mixer or a T-mixer. The mixer is a connector that comprises at least one input for receiving the liquid and the dilutant. The mixer may comprise (as is the case of the Y-mixer and the T-mixer) an input dedicated for receiving the liquid containing the microorganisms and another input configured for receiving the dilutant. The mixer may be configured for receiving (e.g., simultaneously through two independent inputs) the liquid containing microorganisms taken in from the liquid input channel and the dilutant taken in from the dilutant input channel, and supplying (e.g., from a dedicated output) the mixture of the liquid to the microfluidic slide. Thus, the liquid and the dilutant mix are already mixed when entering the microfluidic slide, e.g., to the entry connector comprised in the microfluidic slide, as supplied by the mixer.

The device may include an output channel configured for throwing out the mixture. The output channel may be connected at one end to the output connector comprised in the microfluidic slide. The device may comprise an output port (e.g., arranged on the enclosure of the device) for throwing out the liquid from the output channel. The output port may be connected at one end to the output channel, and at the other end to an output conduit for conveying the mixture to a reception unit e.g., a cube for receiving the throwed out mixture. Alternatively, the output conduit may convey the mixture back to the external liquid medium.

The electronic system may comprise a set of circuits, a processing unit and/or memory. The memory may comprise a computer program comprising instructions that, when executed by the device, cause the device to receive, process data, and sending and/or receiving instructions to (or from) the optics system and/or the fluidics system and to other external systems. The memory may also comprise the computer program comprising instructions configured for causing the processing unit to display the graphical user interface (GUI) on a screen. The screen may be mounted on the device and/or may be remotely located on the remote system. The device may thus communicate remotely to the client computer system, so as to allow remote user-interaction with the device.

The processing unit is configured for receiving and processing of the flux of images from the microscope. In other words, the processing unit communicates with the microscope for receiving the flux of images (e.g., as a stream) and to perform processing of each image, e.g., in real-time or as a post-processing such as, performing compression on one or more images of the received flux, image enhancement and/or storage of the flux of images from the microscope. The processing unit may be configured for receiving the flux of images in any predetermined manner, e.g., as a constant stream, or as packets of images acquired periodically during a predetermined period of time.

The processing unit may be embedded processor, e.g., a Single Board Computer (SBC) such as an Nvidia Jetson type processor or a Raspberry Pi type processor. The embedded processor may thus be attached (e.g., weld) into the electronic system.

Alternatively, one or more of (e.g., all of) the functions of the processing unit may be performed on a remote system, e.g., a server, a client computer system or a tablet device, that communicates with the device.

The electronic system may further comprise a transmission system configured for transmitting the obtained flux of images, e.g., through a network to the remote system. The transmission system may be any set of circuitry configured for processing the obtained flux of images as data packets for its transmittal and/or storage. The transmission system may comprise a wireless transmitter (such as a Wi-Fi transmitter or Bluetooth transmitter) and/or wired transmitter (such as an Ethernet transmitter). The transmission system may be configured to transmit the flux of images to the remote system. The transmission system may be configured for receiving instructions for controlling the fluidics system, the optics system and/or the electronics system.

It is also proposed a kit comprising the device and the remote system. The device may be configured to transmit the flux of images to the remote system, e.g., through the network.

The server may be configured for processing the flux of images. The server may be configured for transmitting instructions to the device for varying the proportion of dilutant in the mixture.

It is also proposed a method for using the kit.

The method comprises providing the device and the remote system. The method comprises transmitting, with the device, the flux of images to the remote system. The method comprises processing, by the server, the flux of images. The method may comprises transmitting, by the server, instructions to the device for varying the proportion of dilutant in the mixture.

The processing unit may be configured for driving the input channels, and for example for varying a proportion of dilutant in the mixture, so as to dilute the liquid received from the liquid input channel. In other words, the processing unit may be configured to send instructions, to the fluidics system, for allowing the taking of dilutant by the dilutant input channel and/or allowing the passage of the dilutant to the microfluidic slide. The fluidics system may comprise motors, valves and/or pumps (such as peristaltic pumps) configured for allowing or stopping the reception, by the microfluidic slide, of the dilutant from the dilutant channel. The device may be configured for supplying selectively the proportion of volume of liquid with respect to the volume of dilutant. In examples, the device may comprise a valve for opening each input of the mixer and/or a motor configured to supply liquid to each input of the mixer, e.g., via a peristaltic pump. The device may selectively open the valve and/or supply the liquid with the motor to each input of the mixer. For example, the method may selectively open the valve of the liquid input channel while selectively closing the valve of the input of the dilutant to the mixer.

Alternatively, the device may comprise a peristaltic pump connected to the dilutant input channel. The peristaltic pump may be configured for changing the speed at which the liquid is carried through the input liquid channel. The device may send instructions to vary the speed of the carrying by the peristaltic pump.

The processing unit may be configured to perform the varying of the proportion of dilutant in any manner. For example, the processing unit may send instructions for allowing completely or stopping completely the reception of the dilutant. For example, an “ON” instruction for completely opening an entry valve from the dilutant input channel to the microfluidic slide and an “OFF” instruction for completely closing said entry valve from the dilutant input channel to the microfluidic slide. Alternatively or additionally, the processing unit may perform more graduate (e.g., stepped or even analog) variations, e.g., it may send a signal corresponding to a percentage of a the closure of the valve, e.g., 50% closure or 75% closure, even 90% closure of the valve, a signal that allows the pass of a volume of the dilutant received by the microfluidic slide during a predetermined period of time. In other examples, the processing unit may send instructions corresponding to a percentage of the speed of the carrying of dilutant by the peristaltic pump, e.g., 50% speed or 75% speed, even 90% speed of carrying by the peristaltic pump (with respect to a maximal carrying speed).

The processing unit may be configured for performing an estimation of a mass of microorganisms in the flux of images. By “estimation of a mass” it is meant that the result of the application (by the processing unit) of any series of image processing operations to the flux of images to obtain a number relative to an area of the flux of images covered by the microorganisms, e.g. the quantity of microorganisms or the area occupied by an agglomeration of the microorganisms on the at least part of the microfluidic slide captured by the flux of images.

The processing unit may be configured to perform the variation of the proportion of dilutant in the mixture based on the estimated mass. In other words, the processing unit may send instructions for allowing or stopping or varying the amount of the reception of the dilutant as a function of the estimated mass. The variation may be performed in any predetermined manner. In some examples, the reception of dilutant may be stopped if there is the estimated mass is below a threshold. In other examples, the amount of received dilutant may be varied according to an increasing function of the estimated mass.

The processing unit may be configured for enabling flow of the dilutant input channel when the estimated mass of microorganisms is above a predetermined threshold, and for disabling flow of the dilutant input channel otherwise. In other words, the method may allow the complete input of dilutant to the microfluidic slide when the estimated mass of microorganisms is above the predetermined threshold and stopping the input when the estimated mass of microorganisms is below the predetermined threshold. The predetermined threshold may be a predetermined area of the image covered by the microorganisms, e.g., a percentage of an area of the image covered by the microorganisms (20% or less, even 10% or less) and/or a predetermined number of objects (which may comprise microorganisms or other elements) detected in the image (e.g., via object detection methods), e.g., 100 objects or less, for example 70 objects or less, yet 50 objects.

Performing the estimation of the mass of microorganisms in the flux of images may comprise applying an adaptive thresholding on the flux of images. By “adaptive thresholding” it is meant any set of techniques known per se in the field of image processing for separating objects in an image from the background. The adaptive thresholding may create at least one segment on the flux of images. By “segment” it is meant any closed shape, such as a square or circle. The area of the at least one segment may comprise at least one or more microorganism. The estimated mass may correspond (approximately or exactly) to the area of the at least one segment, or the sum of the area of the segments when there is more than one segment.

Alternatively, performing the estimation of the mass of microorganisms in the flux of images may comprise applying a neural network classifier on the flux of images. The neural network classifier may be configured to determine the mass of microorganisms on the flux of images. In other words, the neural network classifier may be a machine learnt model comprising classification rules for detecting the mass of microorganisms in the image. For example, the neural network may be configured to determine at least one localization or position (e.g., in x,y-coordinates) comprising a respective estimated mass of the microorganism. The estimated mass may correspond (approximately or exactly) to the estimation of the mass at the at least one localization, or the sum of masses when there is more than one localization.

The device thus improves the analysis of samples of microorganisms. Indeed, as the microfluidic slide is configured to receive the mixture of the liquid from the liquid input channel and of the dilutant from the dilutant input channel, the device allows to modify the density of the microorganisms contained in the liquid, so that the microorganisms are better discriminated (visually) in the captured flux of images. Hence, the device allows a processing, e.g., on-the-fly of the images of microorganisms, thereby reducing waiting times. Hence, the accuracy of the analysis is improved, thanks to the fact that the application of dilutant permits the individual analysis of microorganisms, which would become computationally difficult when the determined mass is above the predetermined threshold.

In examples, the mixture may be varied by the mixer, and thus the density of microorganisms may be varied in any manner so as to allow an improved observation of the microorganisms (e.g., by allowing a relatively large proportion of dilutant to enter so as to allow a better discrimination of the microorganisms). Thus, as the number of objects including the microorganisms is reduced, the processing of the flux of images is more accurate. This is because the density of the objects is also decreased, thereby improving the individual discrimination of all of the elements on the flux of images.

In addition, as the quantity of dilutant is modified, this results in an improved flow of the microorganisms from the microfluidic slide, thereby reducing the possibilities of forming sediments. For example, the processing unit may input the dilutant when determining that a mass of molds in the microfluidic slide is too large (with respect to the predetermined threshold). Thus, the processing unit ensures the molds can be evacuated and continue the image processing afterwards.

Hence, the device benefits of an improvement of the analysis of the samples of microorganisms, all while increasing the reliability of the device in terms of avoiding clogs in the microfluidic slide.

In additional examples, when processing unit performs the variation of the proportion of dilutant in the mixture based on the estimated mass, the processing units sorts out excess of microorganisms when the estimated mass of microorganisms is above the predetermined threshold. The processing may allow, e.g., a maximum of 50 to 70 objects in the image prior to adding dilutant to the mixture (e.g., pure water). This allows an improved analysis of the images, as the electronic system may focus on the individual features of the microorganisms of the images, thanks to the reduced number of objects present in the image. In addition, this avoids sediments of microorganisms, e.g., microorganisms colliding with each other or with other objects, or sediments of molds in liquid coming from large oil tanks.

In addition, the integration of the systems in the device results in a high reliability. This is especially the case when at least one of the fluidics system, the optics system and/or the electronic system is an independent system. Indeed, in this case, the independent system may be independently modulated without the need of interfering with the whole device, e.g., the independent system may be simply replaced. Thus, the device is guaranteed to have reduced downtimes (that is, a time period when the device is not operational).

The optics system may also comprise at least one (e.g., all) of a light source, a light source intensity modulator, an Abbe type condenser, an objective, at least one convergent lens, a diaphragm and an integrated electronic camera. The light source may comprise at least one (e.g., several) LED(s). The intensity modulator is configured to modulate the intensity of the at least one LED. The intensity modulator may be configured to received instructions from the electronic system for modulating the intensity of the light source. The Abbe type condenser may be positioned close to the microfluidic slide and with the at least one convergent lens and the diaphragm.

Thus, the optic system allows to realize an efficient illumination of the microorganisms in the microfluidic slide (e.g., Köhler illumination methods) when capturing the flux of images of the microfluidic slide.

The processing unit may be configured for providing pulsations to the liquid input channel of a first predetermined duration. By “pulsations” it is meant any instruction sent to the fluidics system (e.g., digital pulses such as a train of pulses or analogic electrical stimulus, e.g., an AC pulse) configured for activating or regulating the input of liquid supplied to the microfluidic slide. For example, upon reception of the pulsations, the fluidics system. The processing unit may communicate to the fluidics system so as to open the valve and/or supply the liquid with the motor to each input of the mixer based on the pulsations. For example, the processing unit may send a complete pulsation to the valve for opening completely the valve (e.g., such as an “ON/OFF” control of the valve). In other examples, the processing unit may send a train of pulses (e.g., a PWM pulse) to the (electrical) motor so as to regulate the flow of liquid into the mixer. The first predetermined duration may be set in any predetermined manner. The first predetermined duration may be comprised between 50 ms and 50 s or even 10 ms and 10 ms.

The provided pulsations may be configured so that the liquid input channel takes in liquid from the external liquid medium during the first predetermined duration. In other words, the liquid input channel only takes in liquid when the pulsation is applied.

The capturing of the flux of images from the microscope may comprise stopping the providing of pulsations during a second predetermined duration. In other words, the capturing of the flux of images by the microscope may be performed only when there is no flowing of liquid through the input microfluidic channel. The processing unit may send instructions to the microscope for starting the capturing of the flux of images of the microfluidic slide when the pulsation of the first predetermined duration is over. The second predetermined duration may be set in any predetermined manner so as to allow image capture. The second predetermined duration may be comprised between 50 ms and 3 s or even between 33 ms and 60 ms. The second predetermined duration may be of even 16.66 ms or less.

In examples, the processing unit may provide another pulsation of the first predetermined duration, after the microscope has captured the flux of images during the second predetermined duration, so as to re-start the flow of liquid to the liquid input channel. Alternatively, after the second predetermined duration is over, the microscope may take another flux of images during another second predetermined duration.

This results in the device improving the analysis of samples of microorganisms in liquids. Indeed, as the capturing of the flux of images is performed by stopping the providing of pulsations, the method ensures that the mixture in the microfluidic slide is relatively static, and thus the capturing is more stable and accurate. Indeed, a rapidly flowing mixture may not be captured as accurately as the microorganisms in a rapidly flowing mixture may appear blurred.

The device may further comprise one or more supporting structures. By “supporting structure” it is meant any part or assembly of parts (e.g., mechanical parts) that bears a load or force (e.g., gravitational load) of the device. The one or more supporting structures is arranged so as to define a supporting direction for the device. The supporting direction is thus an oriented line where the bearing of the load or force is concentrated. In other words, the loads exerted on the device follow the supporting direction when the device is installed so as to be supported by the one or more supporting structures.

The microfluidic slide may be arranged in a direction parallel to the supporting direction of the device. In other words, the microfluidic slide is arranged so that the mixture of the liquid flows co-linearly to the supporting direction. The method may comprise arranging the device such that the device is supported vertically (with respect to ground or terrestrial frame), such that the supporting direction is a vertical direction and parallel to the gravity direction. The supporting direction may have the same orientation than the gravity direction or alternatively go in a contrary orientation, e.g., upwards with respect to the sense of gravity. The microfluidic slide may be arranged vertically, and thus along the load born by the one or more supporting structures. This reduces risks of sedimentation. The liquid or mixture may optionally flow upwardly in the microfluidic slide. This further reduces risks of sedimentation.

The microfluidic slide may thus be arranged so as to take in the mixture (of the liquid from the liquid input channel and from the dilutant input channel) and to throw out said mixture along the supporting direction of the device. This enforces a pressure so that the mixture flows in a direction that is colinear (or parallel) to the direction followed by the load born by the one or more supporting structures. This results in a more efficient flow of the mixture through the microfluidic slide and the output channel, as the mixture is enforced to flow parallel to the direction followed by the load, as it follows the pressure enforced by the supporting direction. The output channel and the output port may also be arranged parallel to the supporting direction. This reduces the possibilities that the flow remains blocked, thereby reducing or preventing the formation of sediments or clogs, e.g., masses of microorganisms in the liquid and/or other unwanted elements that may be present in the liquid, such as dirt sediments.

The one or more supporting structures may comprise a supporting surface of the device perpendicular to the supporting direction, in other words, the device is simply supported by its supporting surface which is positioned on a horizontal support, such as a table or the ground. The supporting surface may be a planar (bottom) side of the device, or (bottom) surfaces of feet mounted on the device. Alternatively, the one or more supporting structures may comprise an attachment structure configured for fixing the device on a vertical support or wall, such as a hook structure or a fixation structure mounted on a side wall of the device.

The electronic system may be further configured to determine a universal time and a localization of each captured image. The electronic system may comprise circuitry configured to determine the location of the device and the universal time. The electronic system may optionally comprise a global position system (GPS) chip being configured for obtaining the universal time and the localization of the device. The processing of the flux of images from the microscope may comprise adding obtained universal time and the localization of the device to the flux of images. The method may add, to each image of the flux, a corresponding localization and a respective universal time. The flux of images thus comprises information on the localization in which the flux of images was taken, and the time in which each image was taken. The transmission system may be configured for transmitting the obtained flux of images with the added information. Alternatively, the transmission system may incorporate the corresponding localization and the respective universal time to each image when transmitting the flux of images, e.g., to a remote system.

This results in an improved analysis of the samples of microorganisms, as the flux of images comprises accurate information on the localization and time where the images where taken.

In examples, the GUI may comprise interface screens allowing to selectively activate the transmission of the flux of images. In examples, the GUI may allow the processing unit to process each image so as to be converted to the EXIF format. The processing unit may add the universal time and the localization of the device to each image in the EXIF format. In alternative examples, the transmission system may incorporate the universal time and the localization of the device to the flux of images.

The external liquid medium may be, for example an aqueous liquid contained in a pond of a bioreactor (e.g., an open pond system or a closed pond system) or oil from a large oil tank. Alternatively, the external liquid medium may be a bio-carburant, liquid proceeding from a biological fermentation process, wastewater, water containing phytoplankton, e.g., from an aqueous matrix such as sea water, fresh water or liquid digestate. The external liquid medium may thus come from various industrial fields.

The device is applicable to any type of basin and operation in several industrial fields (of different scales), and is also applicable to laboratory, pilot or industrial reactor (regardless of reactor volume). The device may thus be applicable to civil and/or industrial wastewater treatment plants, or biological reactors containing yeasts, bacteria or arcae. The device may also be applied to raceways, lakes or natural basins, biofuel or green gas productions or other industries such as biofuel production or even fields such as cosmetics, pesticides, pharma, farming, biomaterials.

The device may be portable, that is, small and lightweight so as to allow it to be carried by a user, and to be put into operation in a seamless manner. The device may include one or more handles adapted for allowing it to be carried by the user. The device may be fixed or mobile, e.g., located on a buoy. The device may also comprise one or more batteries so as to be autonomous. The device may also comprise one or more sensors such as one or more temperature sensors, one or more pH sensors, one or more dissolved oxygen sensors, one or more conductivity sensors and/or one or more oxidation-reduction potential sensors.

The device may be reusable, and thus the method may provide the device more than once, e.g., by different persons, in different places or industrial premises, or a single place comprising different external liquid media. In examples, the device may be provided in a first method, and thus the liquid input channel may be connected to a first external liquid medium. The device may be disconnected to the second external liquid medium and then in, a second method, the device may be connected to a second external liquid medium (different from the first medium). The second medium is different from first medium, e.g. different container, within a same industrial premise or in another premise. For example, a user may connect the device to a first microalgae culture and perform the method. After an operation time, the user may disconnect the device and transfer it to a second microalgae culture to perform the method. Alternatively, the device may be reconnected on the same first external liquid medium, although at a different place and at a different time. A plurality of devices may also be connected to a same external liquid medium, thereby allowing massive analysis of images of the liquid medium. Alternatively, a plurality of devices may be connected to different external liquid media. For instance, a first and second device connected to an external liquid medium, a third device to another external liquid medium and so on, thereby allowing massive analysis of images of the liquid medium.

The device analyzes samples of microorganisms in liquids. By “analyzing” it is meant that the device is configured to take a sample of microorganisms as input, perform data acquisition from the sample of microorganisms in liquids and perform data processing operations (such as, e.g., image processing operations) on the acquired data.

The device may be configured for controlling the input volumes of the fluidics system in an open or closed loop with such image analysis. The processing unit may be configured for such control. Alternatively, the device may comprise one or more (e.g., manual) controllers, such as two-positions controller(s) (e.g., ON and OFF controller(s)), or providing alternatively more controlled graduations, e.g., analog control.

The receiving and processing of the flux of images, by the processing unit, may comprise detecting microorganisms present in the flux of images. By “detecting, it is meant that the device is configured to apply image processing techniques for determining the presence of the microorganism with respect to the background of the image. If the processing unit detects microorganisms present in the image, the receiving and processing of the flux of images may comprise estimating a value of one or more biological attributes of microorganisms present in the flux of images. The method may thus first perform the detection of microorganisms prior to estimating the value of one or more biological attributes, if the microorganism is not detected, or only perform the estimation of the value of one or more biological attributes.

By “biological attribute” it is meant any variable having values each forming a piece of information indicative of a biological characteristic of at least one microorganism present in the flux of images. Each value (e.g., numeric or alphanumeric value or vector) of the biological attribute may be related to a biological characteristic of an individual microorganism, or a biological characteristic of the microorganism in interaction with the liquid and/or with other microorganisms present in the flux of images.

In examples, the biological characteristics may comprise the species and/or genera of the microorganism, e.g., with their respective count, or a physiological state characteristic such as a health state, biometric or morphometric measurements.

In examples, the transmission system may incorporate estimated value of the one or more biological attributes of microorganisms present in the flux of images when transmitting the flux of images.

This further improves the accuracy of the analysis of samples. Indeed, thanks to the estimation of the value of one or more biological attributes, the device extracts more accurate information from the microorganisms present in the flux of images. For example, the analyzed flux of images may be enriched with information such as the species of the microorganism, the dimension (such as height) of the microorganism, the number of microorganisms present in the image and/or distribution (or density) of the microorganisms in the image.

The electronic system may comprise a memory having recorded thereon one or more neural networks configured for performing the detection and/or estimation. In other words, the one or more neural networks are configured to receive images of the flux of images (e.g., sequentially) and to output, on each respective image, a respective localization of a detected microorganism and/or values of the one or more biological attributes with input microscopic images.

A neural network is a function comprising a collection of connected nodes, also called “neurons”. Each artificial neuron receives an input and outputs a result to other neurons connected to it. The artificial neurons and the connections linking each of them have weights, which are adjusted via a training process. The input microscope images may be provided raw (e.g., as acquired from the microscope) to the neural network, or alternatively after having been processed by the processing unit (e.g., after being compressed or image-processed).

The processing unit may be configured for applying the one or more neural networks to the flux of images so as to perform the detection and/or estimation. In other words, the processing unit may provide the flux of images to the one or more neural networks as input images, e.g., sequentially in the order as the images are found in the flux of images and to obtain the output by the one or more neural networks as the estimation of the value of one of the biological attributes.

In examples, the processing unit may add the estimated value to the flux of images. The one or more neural networks may determine a respective localization of the at least one microorganism. The one or more neural networks may compute for each respective localization (e.g., bounding box represented by coordinates (x, y) and size, such as width and height) a respective output representing the value of the one or more biological attributes for the at least one respective microorganism. In other words, for localizations each containing at least one microorganism, the one or more neural networks measure the value of the one or more biological attributes of the at least one respective microorganism on its respective localization. The one or more neural networks may provide each outputted value of the one or more biological attributes in the form of one or more labels.

The one or more neural networks may output a different value on a given localization when the one or more neural networks determine that the value computed at the given localization does not correspond to one or more of (e.g., all of) the biological attributes. For example, the one or more neural networks may apply a confidence threshold for determining whether the output satisfies the one or more of the biological attributes. For example, when a respective localization contains an object such as a contaminant, the one or more neural networks may determine that the value computed at the respective localization does not satisfy the confidence threshold for the one or more biological attributes. The one or more neural networks may output a value “other” at the respective localization. The one or more neural networks may have an evolutionary training, that is, a localization not satisfying the one or more of the biological attributes may be used for re-training the one or more neural networks. The one or more neural networks may thus be configured to output new one or more biological attributes (if the object is a biological object).

Alternatively, the processing unit may add the estimated value as a data packet for its transmittal by the transmission system.

Thus, the device leverages from the accuracy achieved by the one or more neural networks to analyze the samples of microorganisms. The use of (trained) neural networks results in relatively fast processing times, all while yielding an accurate estimation of the one or more biological attributes of the microorganisms present in the flux of images.

Each neural network (of the one or more neural networks) may have been trained according to a machine-learning method (i.e., the value of its weights and parameters ensure a level of prediction/inference which reflects such training). The machine-learning method may comprise providing a dataset comprising a set of training patterns.

Applying each neural network and/or the machine-learning method may be as described in the international application No. PCT/IB2021/000279, which is incorporated herein by reference.

As known per se from the field of machine-learning, the dataset impacts the speed of the learning of the one or more neural networks and the quality of the learning, that is, the accuracy of the trained one or more neural networks to analyze the flux of images. The dataset may be provided with a set of training patterns that depends on the contemplated quality of the learning for performing the detection and/or estimation of the microorganisms in liquids. This set may comprise a number of training samples higher than 1 000, 10 000, or yet 100 000 training samples comprising the contemplated variety of microorganisms and/or its biological attributes. The machine-learning method may also leverage from other training patterns of the dataset not included in the set, e.g., training patterns not containing any microorganism, e.g., such as a training pattern comprising images of liquid medium or training patterns comprising images of microorganisms together with other objects such as pollutants. The quantity of the data in the dataset contemplated for the training thus follows a tradeoff between the accuracy to be achieved by the one or more neural networks, and the speed of the training.

Each training pattern may comprise a microscope image of a sample of a liquid medium containing microorganisms (e.g., mold in oils or phytoplankton in seawater) and one or more annotations and/or other objects (such as contaminants). At least one annotation may comprise an indication relative to a presence (e.g., a contour, or a silhouette of the microorganism) in the image of at least one given microorganism. Additionally or alternatively, the training pattern may comprise a plurality of annotations each comprising a localization in the image containing at least one given microorganism. Optionally, the training pattern may comprise a value of one or more respective biological attributes for the at least one given microorganism. Each annotation may be a piece of data that represents an instantiation of a biological attribute of microorganisms present in the microscope image of the sample of microorganisms in the liquid medium. Each annotation may comprise a localization in the image containing at least one given microorganism. For example, an annotation may comprise or consist of a label affixed or associated to the localization of the at least one given microorganism. Each annotation may further comprise a value of one or more respective biological attributes for the at least one given microorganism.

The one or more biological attributes may be from any of a predetermined set of categories for the at least one given microorganism. For example, an annotation of a microorganism may comprise values defining the localization in the image containing at least one given microorganism, e.g., a bounding box represented by coordinates (x, y) and size specifications of the bounding box, such as width and height, and values of one or more biological attributes (e.g., including the species of the microorganisms and or a physiological state such as a health state).

The machine-learning method may also comprise training the neural network based on the provided dataset. As known per se from the field of machine-learning, the training proceeds to adjust the weights of the neural network according to the computed output. As known per se, the output is compared to the values of the annotations in the training samples and the weights may be adjusted according to such comparison. The performance of the accuracy due to learning may be tracked using standard machine-learning methods.

The neural network trained by the machine-learning method thus results in an improved accuracy for analyzing samples of microorganisms in liquids. The output value of the one or more respective biological attributes at each localization in the image containing the at least one respective microorganism allows to make qualitative assessments on the biological status and simultaneously the health of the population of the microorganisms in the sample. Notably, the processing performed by the trained one or more neural networks are particularly fast, compared to a manual assessment of the health of microorganism by using prior art methods, such as high throughput sequencing methods or qPCR. Said methods may take up-to several months for obtaining results. In contrast, the one or more neural networks trained according to the machine-learning method may process the flux of images in a much faster time, e.g., in a matter of minutes or less. The device may analyze, e.g., a flux of images comprising 3600 images per hour or more.

In addition, the device allows the automation of continuous and in situ image analysis (additionally or alternatively, transmission of the analyzed images), all while maintaining the possibility of collecting other physico-chemical parameters. In addition, there is an automated application of the measure thanks to the use of neural networks. Moreover, the use of the device is non-invasive and non-disruptive. Moreover, as the device is portable, this increases responsiveness to adapt the operation of the crop to ensure optimal yield, and thus improves productivity. In addition, the flux of images allows for a massive collection of data for better regular statistics and a better interpretation of the state of cultivation. Moreover, it is easy to maintain and create redundancy if needed.

Examples of the device are now discussed.

The device allows both in situ monitoring of microorganism cultures (such as microalgae/cyanobacteria cultures) by coupling miniaturized microscopy and artificial intelligence. It is also equipped with additional sensors providing the most complete decision support tool for operators.

The device is configured for capturing and analyzing images of microorganisms with trained neural networks. Training of the neural networks may be performed on other dedicated resources such as high performance computers (HPC). Once the training has been carried out, which gives rise to a calibrated neural network, the system can consume this model in order to carry out an analysis of the acquired images (detection/classification of target species).

Examples of components of the device.

The device comprises three systems, ideally independent in their construction and assembly, allowing to modulate the functions without rebuilding an entire system. The systems are: a fluidics system including pumps and mixers, an optical system and an electronic system.

The three systems can be easily opened for intervention or observation. The three modules may be nested in the device and form a single unit (i.e., the device) when assembled.

The optical system is now discussed.

The optical system operates in three possible modes: transmitted light, dark field and phase contrast. A lighting source can be changed to an LED for fluorescence microscopy.

The optical system includes:

an illumination system based on an LED of verifiable quality in batch, i.e. several LEDs of the same batch have a similar temperature for the neural network;

an LED intensity modulator;

an Abbé-type condenser in a fixed position, positioned near the microfluidic blade, with two converging lenses and a diaphragm to allow the implementation of Kohler illumination methods;

an achromat plan microscope objective of sufficient quality for the observation and capture of images of micro-algae with dimensions ranging from 2 μm to 300 μm in hydrodynamic diameter, the objectives envisaged being of x10, x20 and x40 magnification;

a converging lens of high optical quality allowing to reduce the tube distance from 160 mm to ≅50 mm; and

an integrated camera with a resolution equal to or greater than 8 M pixels, allowing the capture of 1080p images at 60 FPS. The optics system may include a Rolling Shutter type camera or a Global Shutter camera.

The fluidics system is now discussed.

The fluidics system allows the continuous observation of solutions and which can be operated in semi-continuous mode to facilitate the observation of objects contained in the liquid. The device comprises a peristaltic pump for taking in liquid from the external liquid medium. The device comprises another peristaltic pump and a mixing system to dilute the liquid. This second pump can optionally be used to clean the fluidics system. The dilution is determined by measuring the turbidity of the solution using an appropriate sensor. In semi-continuous mode, the device may stop the second peristaltic pump until the fluid is stable and can be captured by the optics system with an appropriate resolution.

The fluidics system includes a micro-channel connected to a peristaltic pump, this micro-channel has rectangular dimensions of 5 mm×200 μm in section for entities of less than 100 μm in hydraulic diameter, 5 mm×400 μm up to 5 mm×800 μm for larger species of microorganisms.

The micro-channel is easily removable in case of obstruction or to cover larger species.

Upstream of the micro-channel there may be a filter between 10 μm and 1 mm, for example a 300 μm filter, to prevent the passage of objects that could obstruct the channel. The device may incorporate a mechanism for fixing the micro-fluidic micro-channel in a position orthogonal to the optical system and allowing the micro-channel to be moved to adjust the focus of the microscope.

The electronic system is now discussed.

The electronic system is based for example on an embedded microcontroller (or processor) of the NVIDIA Jetson type or Raspberry Pi type. The microcontroller allows the control of the peristaltic pumps and motors of the micro-fluidic stage by means of an additional card. Obtain the location and precise schedule of the measurements using an additional map. To obtain the measurement of the turbidity of the solution and its possible correction by means of the second peristaltic pump. The electronic system and the pumps operate on a 220V supply.

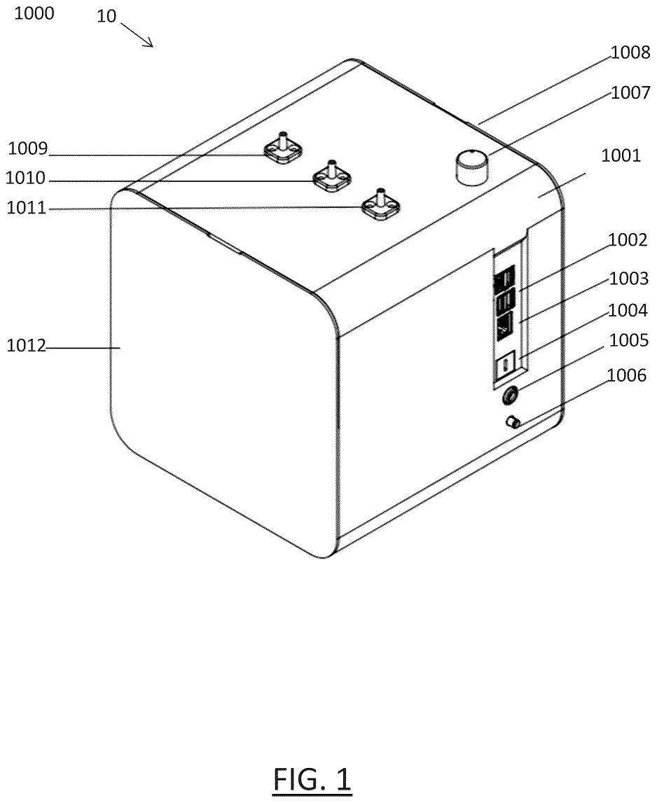

Examples of the device are now discussed with reference to FIGS. 1 to 4.

FIG. 1 shows an isometric view 1000 of the example of the device 10. The device 10 comprises a squared-shape enclosure 1001 with rounded corners, a panel for the transmission system comprising electronic connectors 1002, an ethernet connector 1003, a USB-C connector and a DC connector 1004 for powering the device. The ethernet connector may be used for transmitting the flux of images to a remote system. The device also comprises a DC 9 V connector 1005 for powering the motors that control the peristaltic pumps and a GPS antenna connector 1006. The device may also comprise a Wi-Fi antenna (not shown). The device also comprises three ports 1009-1011, and a knob 1007 for controlling the intensity of the light source in the optics system. The liquid input port 1009 is connected to the liquid input channel (not shown) configured to take in a liquid containing microorganisms from an external liquid medium. The dilutant input port 1011 is connected to the dilutant input channel (not shown) configured to take in dilutant from the dilutant source. The output port 1010 is an outlet for throwing out the mixture. The device also comprises a front door 1012 and a back door 1008. The front door 1012 and the back door 1008 are secured to the enclosure 1001 through magnets.

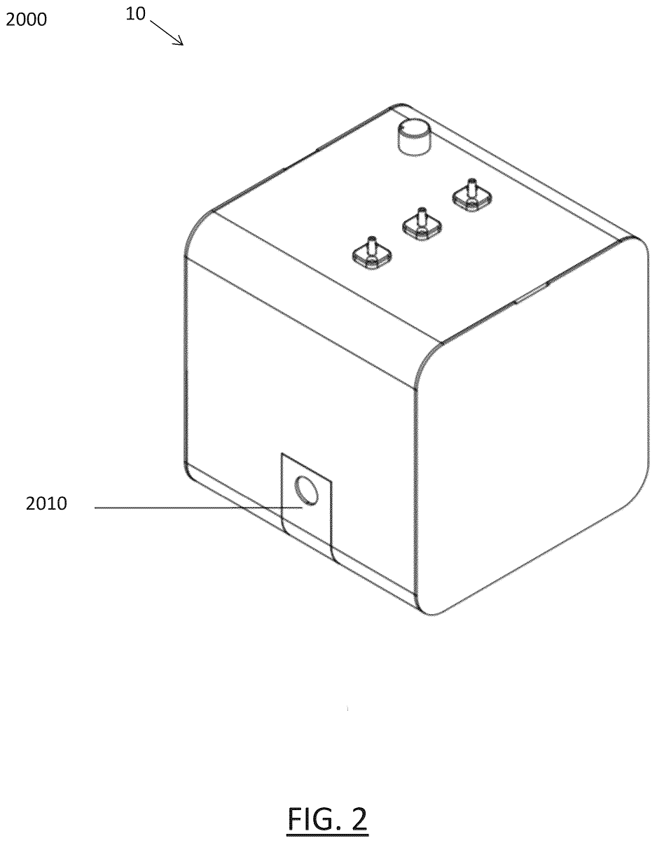

FIG. 2 shows another isometric view 2000 of the device 10. The device 10 also comprises a drawer 2010 that allows the evacuation of liquid, e.g., due to eventual leaks, from the fluidics chamber.

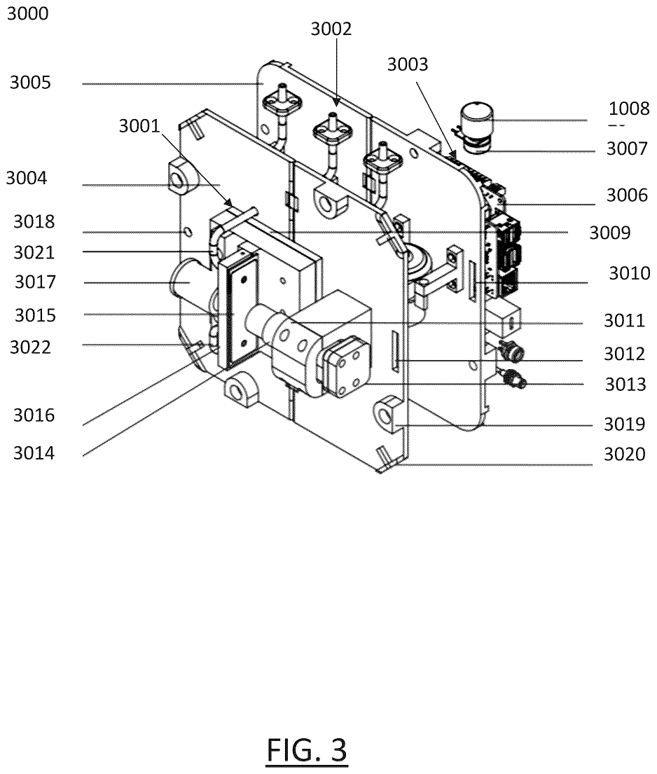

FIG. 3 shows a view 3000 of the device 10 without the enclosure 1001. The device 10 comprises the optics system 3001, the fluidics system 3002 and the electronic system 3003 separated by two walls 3004, 3005. The wall 3004 serves as a base for the attaching the optics of the microscope system 3001. The wall 3004 also separates the optics system 3001 and the fluidics system 3002. The wall 3005 serves for attaching the fluidics system 3002 and the electronic system 3003. The wall 3005 separates the fluidics system 3002 and the electronic system 3003.

The electronic system 3003 comprises a stack 3006 comprising at least two stacked electronic cards, one of the at least two electronic cards may include (e.g., soldered on the electronic card) at least one microcontroller configured to capture and transmit images and a card configured to control the motors of the peristaltic pumps. The at least one microcontroller may comprise an Nvidia Jetson processor and memory storing the one or more neural networks configured for performing the detection and/or estimation. The at least one microcontroller may comprise a transmission system, comprising the Ethernet connector and/or Wi-Fi chip. Alternatively, the transmission system may be another microcontroller arranged on the stack of electronic cards. The electronic system also comprises a potentiometer 3007 used for controlling the intensity of the light source. The potentiometer is driven by a knob 1007, which sits on top of the enclosure 1001. The stack 3006 may optionally comprise a GPS card.

The optics system 3001 comprises a micrometer stage 3009. The micrometer stage 3009 may be a manually operated or optionally motorized. The micrometer stage 3009 is configured to move the sample in a direction parallel to the optical axis. I.e. perpendicular to the sample. The optics system 3001 also comprises slits 3010, 3012, which are passages for a ribbon cable that connects the integrated camera (comprised in the microscope body 3013) of the microscope to the stack 3006 of the electronic system 3003. The optics system also comprises a clamp 3011 for the microscope body 3013. The microscope body 3013 is shortened by using the converging lens with focal distance of 50 mm in order to reduce the length of the tube. The microscope body 3013 comprises a microscope objective 3014 with magnification 10 X, 20 X, 40 X or 60 X. A microfluidic slide 3015 traverses the wall 3004 from the fluidics system and is arranged so as to be imaged by the microscope. The optics system 3001 comprises a support 3016 for the microfluidic slide 3015. The support 3016 is secured to the micrometer stage 3009 through magnets. The optics system 3001 comprises a light source 3017 and including a condenser for the microscope hole 3018. The microscope hole may receive the light from an LED (not shown), which serves as the light source. The wall 3004 comprises a support 3019 for attaching screws used to secure the base plates inside the enclosure 1001. The wall 3004 also comprises ribs 3020 which maintain dimensional stability of the wall 3004, e.g., during cool down. The wall 3004 also comprises inlets 3021 and 3022; the inlet 3021 is attached to the liquid input port 1009, and the inlet 3022 is attached to the dilutant input port 1011, which are inputs and outputs of the microfluidic slide 3015.

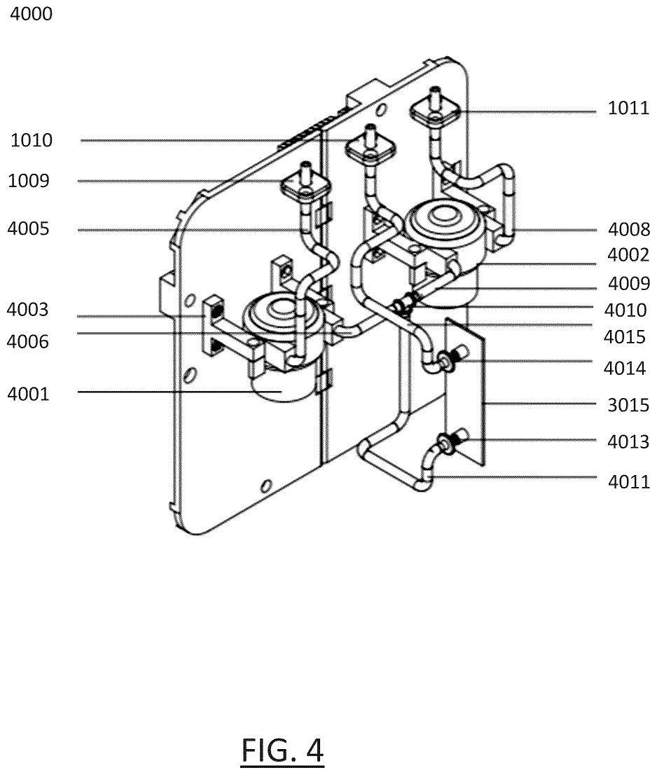

FIG. 4 is another isometric view 4000 of the fluidics system 3002. The fluidics system 3002 includes two peristaltic pumps 4001, 4002. Each peristaltic pump is secured to the plate via T-bars 4003. The liquid containing microorganisms from the external liquid medium is taken in through the liquid input port 1009. The liquid is carried to the peristaltic pump 4001 through the liquid input channel 4005 and then exits the peristaltic pump 4001 through the tube 4006. The electronics system may be configured to vary the speed of the carrying of the liquid by the peristaltic pump 4001. The dilutant is taken in through the dilutant input port 1011. The dilutant is carried to the peristaltic pump 4002 through the dilutant input channel 4008 and exits the peristaltic pump 4002 through the tube 4009. The electronics system may be configured to vary the speed of the carrying of the dilutant by the peristaltic pump 4002. Each of the tubes 4006 and 4009 is attached to an entry of a mixer (e.g., a T-mixer or a Y-mixer) 4010. The mixture output from the mixer 4010 is then carried, through an inlet tube 4011, to the microfluidic slide 3015. The inlet tube 4011 is connected to the slide 3015 through a Luer connector 4013. The mixture moves parallel to the supporting direction defined by the gravitation vector. It exits the microfluidic slide 3015 through the Luer connector 4014. The mixture goes upwards through the output channel 4015 and ends in the output port 1010. The output port 1010 is connected to a cube (not shown) that goes to the waste and serves to throw out the mixture.

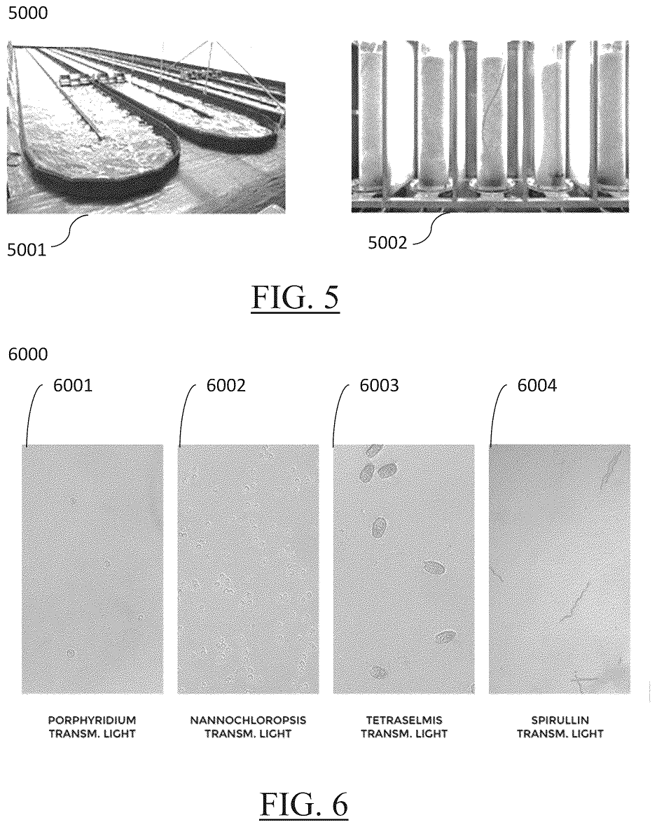

An example of the kit is now discussed with reference to FIGS. 5 to 8.

The kit may be used on an industrial premise.

Reference is made to FIG. 5, illustrating industrial premises 5000 in which the kit may be deployed. The device may be deployed on an open pond system 5001 or on a microalgae culture 5002. The device provides the possibility of simultaneously acquiring information on the biological quality of the culture medium and on the state of the populations of microalgae/cyanobacteria (number, diversity, physiological state) on the industrial premises 5001, 5002. In addition, the device allows in-situ and continuous acquisition of the various parameters. Multiple devices may be placed on different industrial premises to obtain massive data acquisition.

Reference is made to FIG. 6 illustrating images 6000 captured by the optics system. Image 6001 is from a sample of Porphyridium. Image 6003 is from a sample of Nannochloropsis. Image 6004 is from a sample of Tetraselmis. Image 6005 is from a sample of Spirullin.

The remote system may be provided on a remote location, e.g., an office or another building.

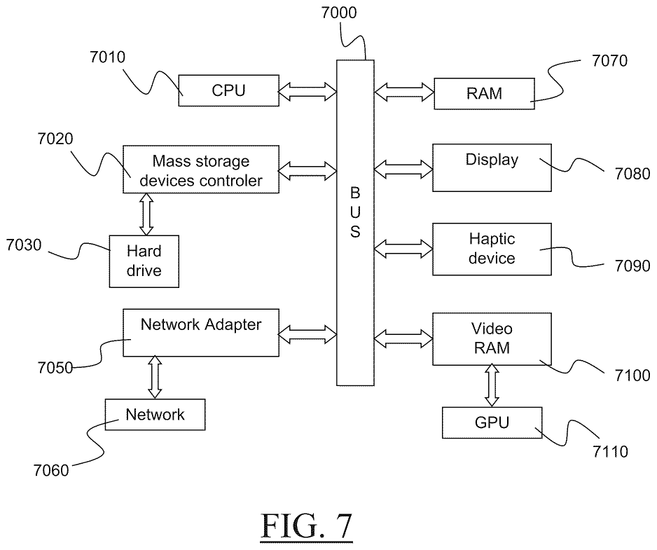

FIG. 7 shows an example of the remote system, wherein the remote system is a client computer system, e.g. a workstation of a user.

The client computer of the example comprises a central processing unit (CPU) 7010 connected to an internal communication BUS 7000, random access memory (RAM) 7070 also connected to the BUS. The client computer is further provided with a graphical processing unit (GPU) 7110 which is associated with video random access memory 7100 connected to the BUS. Video RAM 7100 is also known in the art as a frame buffer. A mass storage device controller 7020 manages accesses to a mass memory device, such as a hard drive 7030. Mass memory devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks. The client computer may comprise a memory storing the computer program comprising instructions configured for causing a processor to display on a screen a graphical user interface (GUI) configured for user-interaction with the device. Any of the foregoing may be supplemented by, or incorporated in, specially designed ASICs (application-specific integrated circuits). A network adapter 7050 manages accesses to a network 7060. The client computer may communicate with the device via the network 7060. The client computer may send or receive instructions from the device. The client computer may receive the flux of images for its posterior treatment through the network adapter 7050. The client computer may process the flux of images from the microscope.

The client computer may also comprise the memory having recorded thereon one or more neural networks configured for performing the detection and/or estimation. The client computer may also comprise applying the one or more neural networks to the flux of images so as to perform the detection and/or estimation.

The client computer may also perform the estimation of the mass of microorganisms in the flux of images, and send instructions to the device through the network adapter 7050 for performing the variation of the proportion of dilutant in the mixture based on the estimated mass.

The kit comprising the client computer and the device may thus form an interconnected system. The client computer may perform one or more functions of the processing unit so as to reduce processing load to the processing unit in the device.

The client computer may also include a haptic device 7090 such as cursor control device, a keyboard or the like. A cursor control device is used in the client computer to permit the user to selectively position a cursor at any desired location on display 7080. In addition, the cursor control device allows the user to select various commands, and input control signals. The cursor control device includes a number of signal generation devices for input control signals to system. Typically, a cursor control device may be a mouse, the button of the mouse being used to generate the signals. Alternatively or additionally, the client computer system may comprise a sensitive pad, and/or the screen. The screen may be a touch sensitive screen. The screen may thus allow interaction with the interface screens of the GUI. The GUI may be configured for receiving the processed flux of images from the device. Alternatively, the GUI may be configured for receiving the flux of images without any processing, and performing processing on the system.

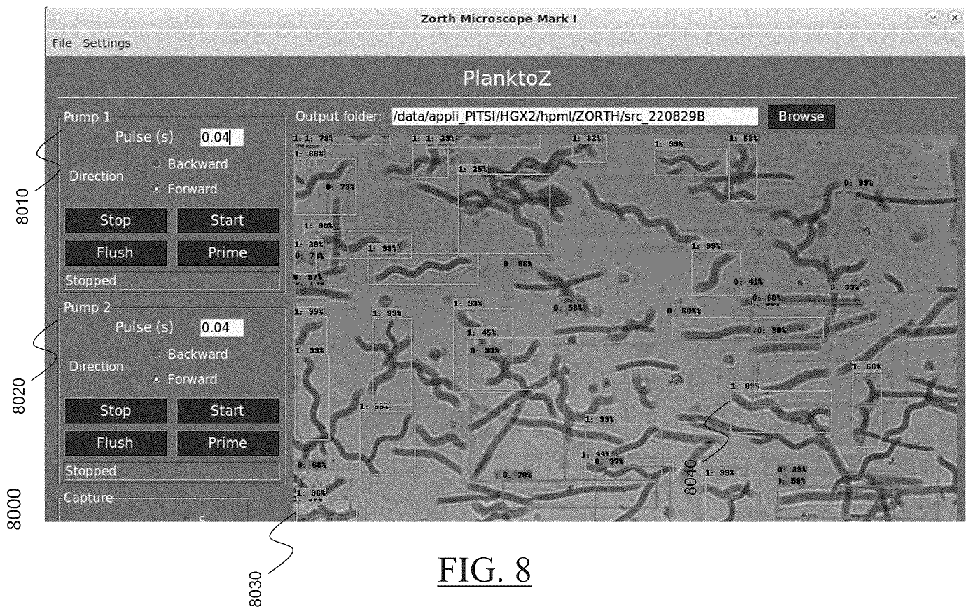

FIG. 8 shows a screenshot 8000 of the GUI.

The GUI is presented as an interface screen on the client computer system. The interface screen comprises a user-interaction section 8010 for sending instructions to the electronic system for varying the speed of the carrying of the liquid by the peristaltic pump attached to the liquid input channel. The interface screen also comprises a user-interaction section 8020 for sending instructions (through the network adapter) to the device, so that the electronic system varies the speed of the carrying of the dilutant by the peristaltic pump attached to the dilutant input channel. The interface screen also comprises an image analysis section 8030 for displaying the analyzed images. The image analysis section 8030 shows an image with respective bounding boxes 8040 for the detected microorganisms.

1-21. (canceled)

22. A method for analyzing samples of liquids containing microorganisms, the method comprising:
in a liquid input channel, receiving a liquid containing microorganisms from an external liquid medium;
in a dilutant input channel, receiving a dilutant from a dilutant source;
in a microfluidic slide, receiving a mixture of the liquid from the liquid input channel and of the dilutant from the dilutant input channel;
capturing a flux of images of the mixture with a microscope; and
receiving and processing the flux of images with a processing unit.

23. The method of claim 22, wherein the external liquid medium is a pond of a bioreactor or an oil tank subject to presence of molds.

24. The method of claim 22, further comprising, by the processing unit, varying a proportion of dilutant in the mixture.

25. The method of claim 24, further comprising, by the processing unit, performing an estimation of a mass of microorganisms in the flux of images, and varying the proportion of dilutant in the mixture based on the estimated mass.

26. The method of claim 25, wherein performing the estimation of the mass of microorganisms in the flux of images comprises applying one of:
an adaptive thresholding on the flux of images, the adaptive thresholding creating at least one segment on the flux of images, the area of the at least one segment comprising at least one or more microorganism, and
a neural network classifier on the flux of images, the neural network classifier being configured to determine the mass of microorganisms on the flux of images.

27. The method of claim 25, further comprising, by the processing unit, enabling flow of the dilutant into the mixture when the estimated mass of microorganisms is above a predetermined threshold, and for disabling flow of the dilutant into the mixture otherwise.

28. The method of claim 22, wherein the receiving and processing of the flux of images comprises detecting microorganisms present in the flux of images and estimating a value of one or more biological attributes of microorganisms present in the flux of images.

29. The method of claim 28, further comprising obtaining one or more neural networks configured for performing the detection and/or estimation and, by the processing unit, applying the one or more neural networks to the flux of images so as to perform the detection.

30. The method of claim 29, wherein each neural network is trained according to a machine-learning method comprising:
providing a dataset comprising a set of training patterns, each training pattern comprising a microscope image of a sample of a liquid medium containing microorganisms and one or more annotations, including at least one annotation comprising an indication relative to a presence in the image of at least one given microorganism, and/or a plurality of annotations each comprising a localization in the image containing at least one given microorganism, and optionally further, a value of one or more respective biological attributes for the at least one given microorganism; and
training the neural network based on the provided dataset.

31. The method of claim 22, further comprising determining a universal time and a localization of each captured image.

32. The method of claims 22, wherein the estimation of the mass microorganisms is performed by determining an area occupied by an agglomeration of the microorganisms on at least part of the microfluidic slide captured by the flux of images.

33. A device for analyzing samples of liquids containing microorganisms, the device comprising:
a fluidics system, the fluidics system comprising a liquid input channel to take in a liquid containing microorganisms from an external liquid medium, a dilutant input channel configured to take in dilutant from a dilutant source, and a microfluidic slide, the microfluidic slide being configured for receiving a mixture of the liquid from the liquid input channel and of the dilutant from the dilutant input channel, wherein the microfluidic slide comprises a liquid channel having a cross-section of thickness between 50 μm and 1 mm and of width between 200 μm and 10 mm;
an optics system, the optics system comprising a microscope, the microscope being arranged for capturing a flux of images of the microfluidic slide; and
an electronic system, the electronic system comprising a processing unit configured for receiving and processing of the flux of images from the microscope.

34. The device of claim 33, wherein the processing unit is configured for varying a proportion of dilutant in the mixture.

35. The device of claim 34, wherein the processing unit is configured for performing an estimation of a mass of microorganisms in the flux of images, and for performing the variation of the proportion of dilutant in the mixture based on the estimated mass.

36. The device of claim 35, wherein performing the estimation of the mass of microorganisms in the flux of images comprises applying one of:
an adaptive thresholding on the flux of images, the adaptive thresholding creating at least one segment on the flux of images, the area of the at least one segment comprising at least one or more microorganism, and
a neural network classifier on the flux of images, the neural network classifier being configured to determine the mass of microorganisms on the flux of images.

37. The device of claim 35, wherein the processing unit is configured for enabling flow of the dilutant into the mixture when the estimated mass of microorganisms is above a predetermined threshold, and for disabling flow of the dilutant into the mixture otherwise.

38. The device of claim 33, wherein the receiving and processing of the flux of images comprises detecting microorganisms present in the flux of images estimating a value of one or more biological attributes of microorganisms present in the flux of images.

39. The device of claim 38, wherein the electronic system comprises a memory having recorded thereon one or more neural networks configured for performing the detection and/or estimation, the processing unit being configured for applying the one or more neural networks to the flux of images so as to perform the detection.

40. The device of claim 39, wherein each neural network is trained according to a machine-learning method comprising:
providing a dataset comprising a set of training patterns, each training pattern comprising a microscope image of a sample of a liquid medium containing microorganisms and one or more annotations, including at least one annotation comprising an indication relative to a presence in the image of at least one given microorganism, and/or a plurality of annotations each comprising a localization in the image containing at least one given microorganism, and optionally further, a value of one or more respective biological attributes for the at least one given microorganism; and
training the neural network based on the provided dataset.

41. A method for analyzing samples of liquids containing microorganisms, the method comprising:
providing a device, the device comprising:
a fluidics system, the fluidics system comprising a liquid input channel to take in a liquid containing microorganisms from an external liquid medium, a dilutant input channel configured to take in dilutant from a dilutant source, and a microfluidic slide, the microfluidic slide being configured for receiving a mixture of the liquid from the liquid input channel and of the dilutant from the dilutant input channel, wherein the microfluidic slide comprises a liquid channel having a cross-section of thickness between 50 μm and 1 mm and of width between 200 μm and 10 mm;
an optics system, the optics system comprising a microscope, the microscope being arranged for capturing a flux of images of the microfluidic slide; and
an electronic system, the electronic system comprising a processing unit configured for receiving and processing of the flux of images from the microscope;
connecting the liquid input channel to an external liquid medium containing microorganisms;
taking liquid from the external liquid medium into the liquid input channel;
at the microfluidic slide, receiving the liquid from the input liquid channel or a mixture of the liquid from the liquid input channel and of dilutant from the dilutant input channel;
capturing a flux of images of the microfluidic slide with the microscope;
receiving and processing the flux of images with the electronic system.

42. The method of claim 41, wherein the method comprises arranging the device such that the device is supported vertically, the microfluidic slide being arranged vertically, the liquid or mixture optionally flowing upwardly in the microfluidic slide.
